(19) United States
(12) Patent Application Publication
(10) Pub. No.: US 2020/0298892 A1
(43) Pub. Date: Sep. 24, 2020

(54) VEHICLE TO VEHICLE (V2V) COMMUNICATION LESS TRUCK PLATOONING

(71) Applicant: CARTICA AI LTD, Tel Aviv (IL)

(72) Inventors: Igal Raichelgauz, Tel Aviv (IL); Karina Odinaev, Tel Aviv (IL)

(73) Assignee: CARTICA AI LTD, Tel Aviv (IL)

(21) Appl. No.: 16/896,109

(22) Filed: Jun. 8, 2020

Related U.S. Application Data
(63) Continuation-in-part of application No. 16/729,320, filed on Dec. 28, 2019.
Application No. 16/729,320 is a continuation of application No. PCT/IB2019/058207, filed on Sep. 27, 2019.
(60) Provisional application No. 62/827,112, filed on Mar. 31, 2019.
(60) Provisional application No. 62/750,822, filed on Oct. 26, 2018.
(60) Provisional application No. 62/747,147, filed on Oct. 18, 2018.
(60) Provisional application No. 62/827,112, filed on Mar. 31, 2019.

(51) Int. Cl. B60W 60/00; G08G 1/00; B60W 50/14; B60W 40/09

(52) U.S. Cl. CPC B60W 60/00272; G08G 1/22; B60W 60/0025; B60W 2050/146; B60W 60/0051; B60W 40/09; B60W 2300/12; B60W 50/14

(57) ABSTRACT

A method for at least partial autonomous driving based on one or more other vehicles, the method may include (i) detecting a trusted vehicle within an environment of a first vehicle, the first vehicle is destined to follow a first path and reach a first target location, the trusted vehicle is destined to follow a second path; (ii) determining, based on at least a spatial relationship between the first path and the second path, at least one out of: (a) whether to perform an at least partial autonomous driving session that involves at least partially automatically following the trusted vehicle, and (b) whether to suggest to a human driver of the first vehicle to authorize the first vehicle to perform the at least partial autonomous driving session; and responding to the determination.

### CROSS REFERENCE

This application is a continuation in part of U.S. patent application Ser. No. 16/729,320 filing date Dec. 28, 2019.

U.S. patent application Ser. No. 16/729,320 is a continuation in part of PCT/IB2019/058207 filing date Sep. 27, 2019 which in turn claims priority from U.S. provisional Ser. No. 62/747,147 filing date Oct. 18, 2018.

U.S. patent application Ser. No. 16/729,320 claims priority from U.S. provisional patent Ser. No. 62/827,112 filing date Mar. 31, 2019,

All patent applications are incorporated herein by reference.

### BACKGROUND

Truck platooning is the linking of two or more trucks in convoy, heavily based on connectivity technology and automated driving support systems. These vehicles automatically maintain a set, close distance between each other when they are connected for certain parts of a journey, for instance on motorways.

Truck platooning holds great potential to make road transport safer, cleaner and more efficient in the future.

Platooning results in a lower fuel consumption, as the trucks drive closer together at a constant speed, with less braking and accelerating.

Truck platooning has the potential to reduce CO2 emissions by up to 10%.
With conventional trucks, critical risk factors are driver reaction time and concentration. Indeed, some 90% of all traffic accidents are due to human error.

Allowing for more predictive driving of trucks on the road, platooning also improves safety for other road users.

Platooning is a cost-saver, as lower fuel consumption means lower fuel costs, which currently make up 30% of total operating costs of a truck.

Truck platooning is based on communicating between trucks using propriety vehicle to vehicle (V2V) communication protocols that are relatively costly and is limited to performing truck platooning of trucks that are operated by the same company that leave the facility together and travel the same route till the end of the journey.

There is a growing need to provide more flexible method of truck platooning.

### SUMMARY

### BRIEF DESCRIPTION OF THE DRAWINGS

The embodiments of the disclosure will be understood and appreciated more fully from the following detailed description, taken in conjunction with the drawings in which:

FIG. 1 is an example of a method;

FIG. 2 is an example of a method; and

FIG. 3 is an example of a method.

### DESCRIPTION OF EXAMPLE EMBODIMENTS

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a spanning element. A spanning element may be implemented in software or hardware. Different spanning element of a certain iteration are configured to apply different mathematical functions on the input they receive. Non-limiting examples of the mathematical functions include filtering, although other functions may be applied.

The specification and/or drawings may refer to a concept structure. A concept structure may include one or more clusters. Each cluster may include signatures and related metadata. Each reference to one or more clusters may be applicable to a reference to a concept structure.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to a truck should be applied mutatis mutandis to a vehicle—including a vehicle that is not a truck such as a car.

The following terms are used in the specification:

A “trusted driver” is a driver that has a trust level that may fulfill one or more predefined conditions. For example—the trust level may be at least of a predefined value (for example above a predefined threshold), and/or may fulfill at least one condition in relation to trust levels of one or more other drivers.

For example—the trust level (of the trusted driver) may exceed a certain threshold or may equal the certain threshold.

For example—the trusted driver may be required to pass a certain test, and/or successfully complete a certain training process and/or have a driving license of a certain type (for example a public transportation driver license, such as a taxi driver license, a bus driver license).

The certain threshold and/or the trust level of the driver may be calculated in any manner For example—the certain threshold and/or the trust level may be determined based on history (accidents, police reports, insurance claims) of one or multiple drivers.

The certain threshold may be determined by any entity (for example an entity that is responsible for developing and/or maintaining an application or service used by one or more drivers for finding the trusted driver).

The certain threshold may be determined based on social rankings (for example feedback from drivers that followed the driver, feedback provided by passengers of the driver, and the like).

The trust level of the trusted driver and/or the certain threshold can be determined to be above the trust level of some (for example—a certain number or a certain percent—for example above 40, 50, 60, 80, and even 90 percent)) of drivers of a group of drivers (the group may include the entire drivers population, a part of the entire drivers population) and the like, a trusted driver may be required to undergo a certain certification or training process, and the like.

If, for example, a requesting driver has a certain trust level then the trust level of a trusted driver may be determined based on the trust level of the requesting level—for example may exceed the trust level of the requesting driver by a certain margin, by a certain factor, and the like.

The trust level may be determined based on any combination of the mentioned above examples, parameters and the like.

“At least partial autonomous driving session” means a driving session in which the vehicle drives in a fully autonomous manner, or in a partial autonomous manner The at least partial autonomous driving session may or may not include deviations from driving pattern dictated by the trusted driver. The at least partial autonomous driving session may or may not include monitoring the driving session (constantly or in a non-continuous manner) and responding to deviation from allowable and/or recommended driving rules that may occur when following the driving session.

Any deviations from the driving pattern dictated by the trusted driver may be introduced. For example—performing automatic lane maintenance maneuvers, autonomously introducing safety measures such as keeping at least a predefined distance between the vehicle and the trusted driver, keeping the speed and/or acceleration and/or deceleration and or any movement related parameter of the vehicle within certain limits—even when the trusted driver deviates from these limits, and the like.

The monitoring may include monitoring commands and/or other information communicated by the trusted driver using any communication method (for example using vehicle to vehicle communication channels, or other channels).

The monitoring may include monitoring the environment of the vehicle using one or more sensors. Non-limiting example of such monitoring is illustrated in U.S. patent application Ser. No. 16/729,320 filing date Dec. 28, 2019

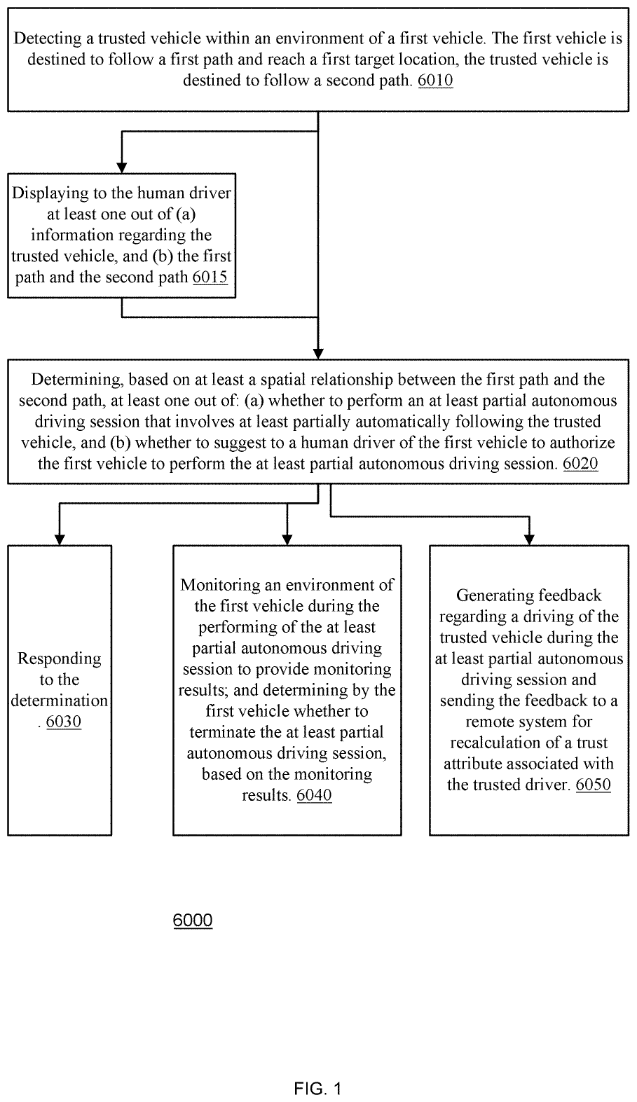

FIG. 1 illustrates method 6000 for at least partial autonomous driving based on one or more other vehicles.

Method 6000 may start by step 6010 of detecting a trusted vehicle within an environment of a first vehicle. The first vehicle is destined to follow a first path and reach a first target location, the trusted vehicle is destined to follow a second path.

The detecting of the trusted vehicle may include sensing (for example by an image sensor) vehicles within the environment of the first vehicle, identifying (for example using image processing or any other method) the vehicles and/or drivers within the environment of the first vehicle and then determining whether the first environment includes the trusted vehicle. The determining may include accessing a data structure that includes identifications (for example license plate numbers) associated with trusted drivers.

The detecting may be executed in any other manner

The locations of trusted driver may be transmitted or otherwise be known to a computerized system that may also be aware of the location of the first vehicle.

The first target location may be known from the driver, from a passenger of the first vehicle, or may be known or estimated in any other manner The same applies to the first paths.

The computerized system may determine that the environment of the first vehicle includes one or more trusted driver and send an indication regarding their presence. For example—the first vehicle may include a unit that may executed an application (or other code) that may display the location of the trusted vehicles—especially in relation to the location of the first vehicle. The display may be of any form—for example displaying marks on a map.

The detection of the driver may also refer to a future point of time—and to a future route to be taken by the driver of the first vehicle and the future paths taken by the trusted driver within an environment in which the driver will be in the future point of time. The driver may elect the future point of time. For example—the first driver wants to go from Sunnyvale to San Jose on Monday 9 am, and step 6010 may include finding trusted drivers that plan this route around the mentioned future point in time. Thus the method may proceed mutatis mutandis in relation to the future point in time. Additionally or alternatively—the user may select a target and the method may evaluate different future times of driving and may select or suggest one of these different future times based at least on the trusted drivers available, or any other parameter related to the path.

The path of the trusted driver may be estimated, known to the computerized manner, published by the trusted drivers, and the like.

Step 6010 may be followed by step 6015 or may be followed by step 6020.

Step 6015 may include displaying to the human driver at least one out of (a) information regarding the trusted vehicle, and (b) the first path and the second path. Step 6015 may be followed by step 6020.

Step 6020 may include determining, based on at least a spatial relationship between the first path and the second path, at least one out of: (a) whether to perform an at least partial autonomous driving session that involves at least partially automatically following the trusted vehicle, and (b) whether to suggest to a human driver of the first vehicle to authorize the first vehicle to perform the at least partial autonomous driving session.

Step 6020 may include calculating a function that takes into account the benefits and disadvantages of performing the partial autonomous driving session and determine whether to perform the partial autonomous driving session or not—and if so—when to end the partial autonomous driving session. The benefits may include fuel reduction, less usage of brakes when platooning, reduction of a load imposed on a human driver and/or an autonomous driving module when following the trusted driver, an increase in a safety level associated when following a trusted driver, saving of time, and the like.

The determination may be also based on at least one on (a) the awakens level and/or the stress and/or any aspect of the status of the driver of the first vehicle (a tired and/or a stressed driver may tend to at least partially autonomously follow a trusted driver), (b) the driving history of the driver of the first vehicle (for example—if the driver never drove to its destination then he may tend to least partially autonomously follow a trusted driver), (c) the status of the first vehicle—for example the fullness level of the fuel tank or battery of the first vehicle and locations of gas stations or charging stations, and the like.

Accordingly—step 6020 may include determining (a) without determining (a), determining (b) without determining (a), or determining (a) and (b).

Step 6020 may include determining based, at least in part, on a spatial relationship between the first path and the second path.

The spatial relationship may include the overlap of the paths—especially overlaps between different segments of the paths. For example—The first vehicle may follow the second vehicle while the segments overlap.

Step 6020 may include obtaining a driving profile of the human driver, obtaining a driving profile of the trusted vehicle, calculating a similarity between the driving profile of the human driver and the driving profile of the trusted vehicle, and wherein the determining is based, at least in part, on the similarity.

Step 6020 may be based, at least in part, on a number of vehicles that are already engaged in at least partially automatically following the trusted vehicle. The attractiveness of following the trusted vehicle can decrease with an increase in the number of followers.

The first vehicle is associated with a first trust level and the trusted vehicle is associated with a second trust level. The determining of step 6020 may be based at least in part on the first trust level and on the second trust level.

Step 6010 may include detecting at least one additional trusted vehicle within the environment of the vehicle, wherein the at least one additional trusted vehicle is destined to follow at least one path. In this case, step 6020 may include selecting a trusted vehicle of the first trusted vehicle and the at least one additional trusted vehicle. In this case, step 6020 may include selecting, for each first path segment out of multiple first path segments, a trusted vehicle of the first trusted vehicle and the at least one additional trusted vehicle.

It should be noted that the driver may elect which trusted driver to follow and in this case step 6020 may be bypassed.

Step 6020 may be followed by step 6030 of responding to the determination.

Step 6030 may include
i. Performing the at least partial autonomous driving session when determining to perform the at least partial autonomous driving session.
ii. Not performing the at least partial autonomous driving session when determining not to perform the at least partial autonomous driving session.
iii. Suggesting the human driver to authorize the first vehicle to perform the at least partial autonomous driving session, when determining to suggest the human driver to authorize the first vehicle to perform the at least partial autonomous driving session.
iv. Not suggesting the human driver to authorize the first vehicle to perform the at least partial autonomous driving session, when determining not to suggest the human driver to authorize the first vehicle to perform the at least partial autonomous driving session.

When performing the at least partial autonomous driving session—step 6030 may include utilizing vehicle to vehicle communication between the first vehicle and the trusted vehicle. Alternatively—step 6030 may be executed without utilizing vehicle to vehicle communication between the first vehicle and the trusted vehicle.

Method 6000 may include step 6040 of monitoring an environment of the first vehicle during the performing of the at least partial autonomous driving session to provide monitoring results; and determining by the first vehicle whether to terminate the at least partial autonomous driving session, based on the monitoring results. Step 6040 may be executed in parallel to step 6030, or during at least a time window within a period of time in which step 6030 is executed.

When performing the at least partial autonomous driving session, the first vehicle may determine whether to terminate the at least partial autonomous driving session when the platoon is broken (e.g. by a traffic light, or a car entered between the cars in the platoon, etc). Upon a termination or before the termination an alert may be generated to the human driver.

When deciding to perform the at least partial autonomous driving session—the trusted driver may be notified about the decision. The trusted driver may or may be requested to authorize the performing of the at least partial autonomous driving session by the first vehicle. If requested to authorize or if the trusted driver may cancel or reject the attempt of the first vehicle to perform the at least partial autonomous driving session then the at least partial autonomous driving session may not proceed. The trusted driver may request the first driver and/or the first vehicle not to proceed with the at least partial autonomous driving session. The response of the trusted driver may be based on any reason—for example—based on an assessment of a risk to the whole convoy.

It should be noted that notifying the trusted driver about the vehicle that follow him may affect the driver's decision and thus increase the safety associated with the platooning.

For example—if the first driver has many vehicles in the platoon, and he sees a green light that is green for a long time already and there is a chance to become yellow, he might decide to slow down and continue on a fresh green light.

Method 6000 may include step 6050 of generating feedback regarding a driving of the trusted vehicle during the at least partial autonomous driving session and sending the feedback to a remote system for recalculation of a trust attribute associated with the trusted driver. Step 6050 may be executed in parallel to step 6030, or during at least a time window within a period of time in which step 6030 is executed.

Method 6000 may be initiated and/or terminated under the control of a human driver of the first vehicle, and/or under the control of an autonomous or driver assistance module of the first vehicle.

The following section provides example of truck platooning. Any of the steps illustrated below may be applied, mutatis mutandis, during the partial autonomous driving session.

Truck platooning is the linking of two or more trucks in convoy, heavily based on connectivity technology and automated driving support systems. These vehicles automatically maintain a set, close distance between each other when they are connected for certain parts of a journey, for instance on motorways.

Truck platooning holds great potential to make road transport safer, cleaner and more efficient in the future.

Platooning results in a lower fuel consumption, as the trucks drive closer together at a constant speed, with less braking and accelerating.

Truck platooning has the potential to reduce CO2 emissions by up to 10%.
With conventional trucks, critical risk factors are driver reaction time and concentration. Indeed, some 90% of all traffic accidents are due to human error.

Allowing for more predictive driving of trucks on the road, platooning also improves safety for other road users.

Platooning is a cost-saver, as lower fuel consumption means lower fuel costs, which currently make up 30% of total operating costs of a truck.

The V2V communication is used to convey commands from the front truck to the autonomous driving models that autonomously drive the trucks that blindly follow the front truck.

Alternatively, the platooning may be executed in a V2V communication-less based manner in which the platooning is not based solely on V2V communication—and in which the following trucks do not blindly follow the leading truck—based solely on commands (conveyed by the V2V communication).

Each truck may determine, even without communicating with other trucks of the convoy, when to engage in the platooning, how do drive during the platooning and if required—how to disengage from the platooning.

Each truck may decide, from time to time—in a continuous or non-continuous manner on a noncontinuous basis whether to maintain in the convoy—the determination can be made when the preceding truck turns into a path that is not a part of the desired path of the truck, when a vehicle cuts between the truck and another member of the convoy, when the preceding truck drives in a dangerous manner).

Each truck may apply at least a partial autonomous driving while being engaged in the platooning—while basing its behavior on sensed information obtained by the truck and by following one or more autonomous driving policy. The sensed information may include image or non-image information, may be sensed by active sensor (LIDAR) or passive sensor, may include, for example information sensed by visual sensor, infrared sensor, thermal sensor, radar, sonar, and the like.

At least partially autonomously man mean performing some driving assistance operation by the vehicle such as at least one out of adaptive cruise control, lane monitoring, maintaining a distance between the truck and a preceding truck of the convoy—till fully autonomous driving. For example—while in the convoy the truck may apply at least one out of adaptive cruise control (keeping safe distance between the truck and preceding truck—for example by measuring the speed of the preceding truck, identify that the brake light of the preceding truck indicate that it stops, identify lane and drivable paths—for example in order to detect the truck from following the preceding truck into the shoulders of the road, track the exact location of the preceding vehicle to maintain alignment between the truck and the preceding truck).

Trucks of the convoy may attempt to exchange information over V2V communication—but the platooning is not based on said communication.

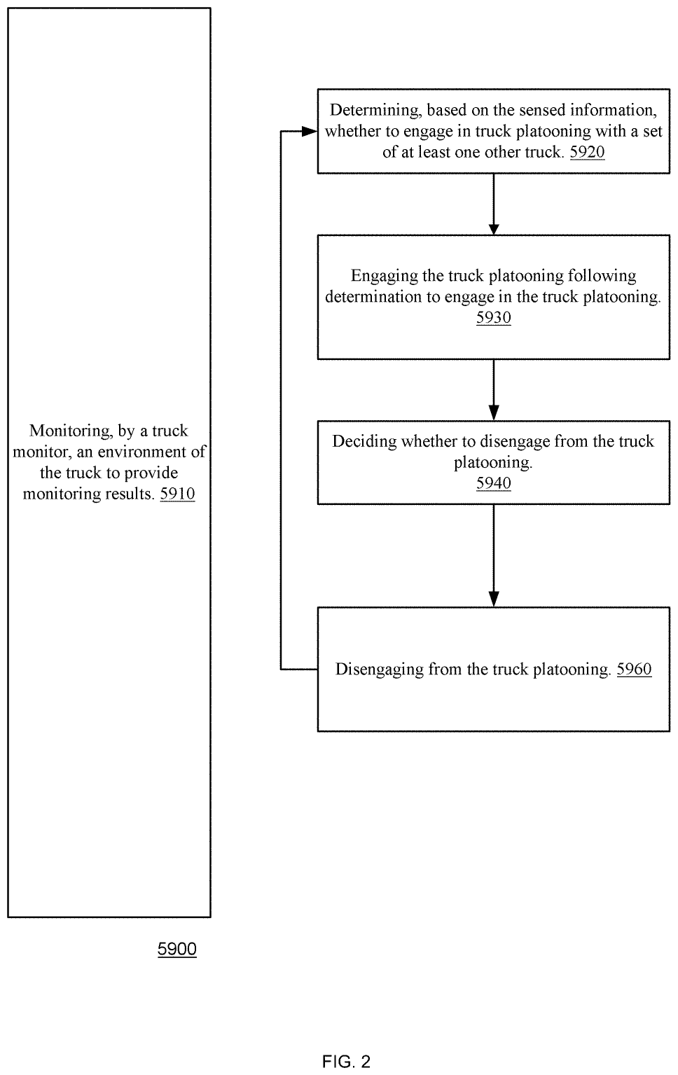

FIG. 2 illustrates method 5900.

Method 5900 may start by steps 5190 and 5920.

Step 5910 may include monitoring, by a truck monitor, an environment of the truck to provide monitoring results. Step 5910 may include generating sensed information regarding an environment of a truck and processing the sensed information. Step 5910 may continue while the truck is driving, before entering the platoon, while platooning, when disengaging from the platoon and after disengaging from the platoon.

Step 5920 may include determining, based on the sensed information, whether to engage in truck platooning with a set of at least one other truck.

Assuming that a certain truck executed method 5900.

The set of trucks (before or after the certain truck joins them) can be regarded as a convoy.

The decision of whether to engagement may be based on at least some of the following parameters: a size of one or more trucks of the convoy, a size of the certain truck, a shape of one or more trucks of the convoy, a shape of the certain truck, a weight of one or more trucks of the convoy, a weight of the current truck, a path of the convoy, a path of the certain truck, and the like.

The shape, size and weight may affect the fuel saving which is one of the major benefits of the platooning. For example—a heavy truck (for example class 7 or class 8 truck) usually will not follow a convoy of light or medium trucks (for example classes 1, 2A, 2B, or 3).

The shape, size and weight may affect yet another parameter that should be taken into account when deciding to engage in platooning. For example—behavior considerations, e.g. time to stop, safe distance, safe speed etc—that differ for different types of trucks.

Step 5920 may also include determining how to engage—including the location within the convoy—whether to become a leading truck, whether to become a following truck, the order of truck in the convoy, and the like.

How to engage may include determined whether the engagement is to be done autonomously or under the control of a human driver.

How to engage may including, timing of engagement, driving the preceded the engagement, and the like. The engagement can be executed while autonomously driving or while the truck is controlled by a driver (human)—with or without driver assistance module involvement.

Step 5920 may be followed by step 5930 of engaging the truck platooning following determination to engage in the truck platooning.

Step 5920 and 5930 may include determining a distance between the truck and the preceding truck of the convoy.

The distance may be dependent on the current speed of the convoy, on the risk level associated with the currently passed road, segments, and the like.

Step 5930 may include at least partially autonomously driving the truck based on monitoring results obtained during the engaging, while engaging in the truck platooning.

Step 5930 may also be followed by step 5940 of deciding whether to disengage from the truck platooning.

When determining to disengage then step 5940 may be followed by step 5950 of disengaging—leaving the convoy.

Step 5950 may be followed by step 5920—in order to enable the truck to reengage in the truck platooning—either with the previous convoy or with a new convoy.

There may be a predefine delay between consecutive decisions to engage and disengage—in order to reduce multiple repetitions of engagement and disengagements.

Repetitions of disengaging and reengaging may be executed in various manner—for example
Temporarily disengaging from the platoon when a vehicle that should not belong to the platoon enters a gap between two consecutive trucks of the convoy. Once the vehicle exits said gap the truck may reengage.
Replacing places between members of the convoy—for example replacing the leading truck—so that the disadvantages resulting from being a leading truck (for example—no fuel saving) can be distributed between different members of the convoy.

The members of the convoy may replace locations within the convoy in a predefined manner, in a pseudorandom manner, or a random manner, following and event (for example after passing a predefined distance, and the like).

Each one of steps 5920, 5930 and 5940 may be based in various considerations. These considerations may define, for example, the distance between the certain truck and the preceding truck. The distance may change over time (dependent on other considerations such as speed, risk, and the like).

These considerations may include at least one out of the benefits in platooning (fuel saving, simpler autonomous driving) versus the downfalls of platooning (smaller distances between the trucks).

Any cost function or tradeoff between the benefits and the downfalls of platooning may be applied.

The risk associated with platooning may be determined in various manners and/or may be dependent on one or more factors—such as (a) the state of the road—for example grip level, slipperiness, (b) weather conditions—rain , snow, ice, fog, illumination, sunny, windy, twilight, sunrise, (c) manner in which the certain truck is forced to drive, (d) the risk level associated with the environment of the convoy (traffic load, steepness of road segments, velocity of driving, urban versus open country environment), type of vehicles (cars, motorcycles, bicycles, scooters), presence or absence of pedestrians), and the like.

The manner in which the truck was forced to drive while platooning can be evaluated in various manners—for example:
Whether it followed a safe driving profile (may be determined in advance) while platooning.
Whether while driving in the convoy the driving of the truck was more aggressive than when driving independently.
Whether risky events occurred—for example—whether rule traffic violations occurred (passing in red light, driving without stopping in front of a stop sign, exceeding the allowed speed limit).

The risk may be associated in a continuous manner, in a non-continuous manner, randomly, pseudo-randomly, due to events, and the like.

The risk may be based by applying a machine learning process trained to identify risky driving.

The considerations may include the amount of changes in the number of members of the convoy, the rate of location exchanges in the convoy, and the like. For example—too many changes may reduce the safety level of the convoy.

The considerations may also include the physiological state of the driver. For example—if the driver is tired or stressed then joining a convoy as a following truck may allow autonomous driving that may not be allowed without platooning.

The considerations may include the overlap between the current path of the convoy and the desired path of the truck. The method may allow deviations from the desired path—but the deviations should still be more beneficial (for example in fuel saved) than skipping these deviations.

The considerations or the tradeoff may be leant by supervised or unsupervised machine learning process.

The entrance of one or more vehicles between the certain truck and a previous truck of the convoy may cause the certain truck to disengage—either temporarily or not. Such one or more vehicles (that should not belong to the convoy) are usually associated with lower trust level (for example are not autonomously driven).

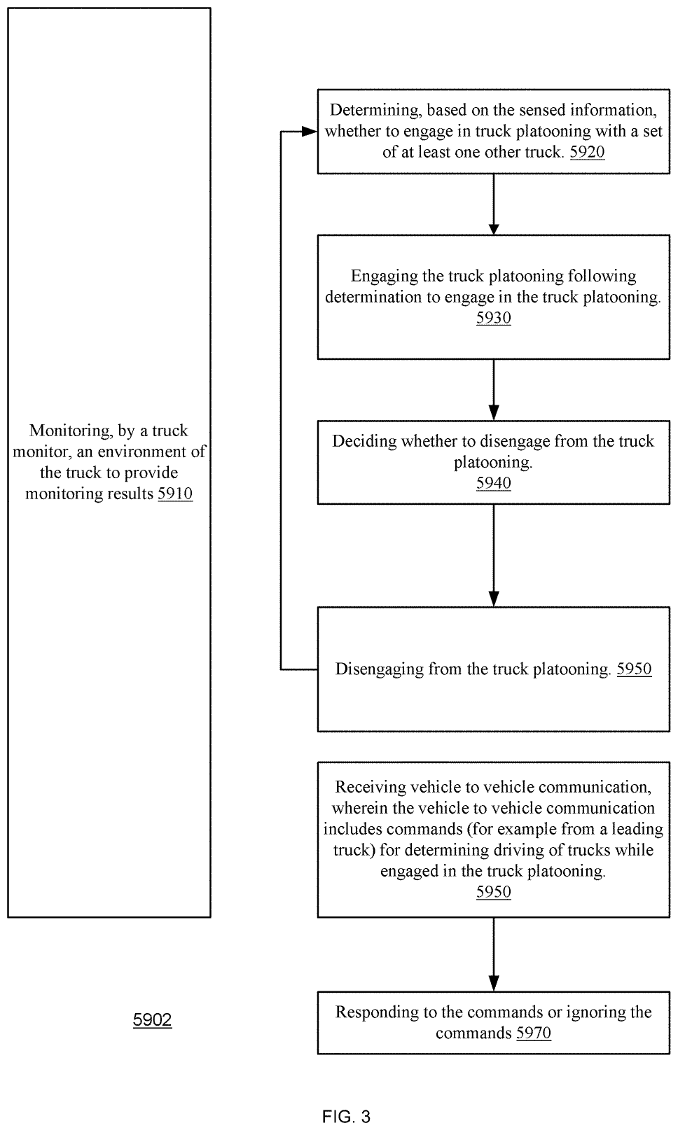

FIG. 3 illustrates method 5902.

Method 5902 differ from method 5900 of FIG. 59 by including steps 5960 and 5970.

Step 5960 may include receiving vehicle to vehicle communication, wherein the vehicle to vehicle communication includes commands (for example from a leading truck) for determining driving of trucks while engaged in the truck platooning.

Step 5960 may be followed by step 5970 of responding to or ignoring the commands

Step 5970 may include at least partially autonomously driving the truck regardless of the commands

Step 5970 may include analyzing an accuracy of the commands and generating an alerts when the commands are inaccurate.

For example—if the convoy stops and the commands are to accelerate—then the commands are inaccurate—even may eb a result of a jamming attempt.

Step 5970 may include (instead of or in addition to the generating of the alert) increasing the risk associated with the platooning and/or leaving the convoy.

There may be provided a method for vehicle to vehicle communication less vehicle platooning, the method may include monitoring, by a vehicle monitor, an environment of the vehicle to provide monitoring results; determining, based on the sensed information, whether to engage in vehicle platooning with a set of at least one other vehicle; engaging the vehicle platooning following determination to engage in the vehicle platooning; wherein the engaging comprises at least partially autonomously driving the vehicle based on the monitoring results.

The method may include determining, based at least on the monitoring results, whether disengage the vehicle platooning.

At least one of the determining of whether to engage and whether to disengage may be based on a risk level associated with the vehicle platooning.

At least one of the determining of whether to engage and whether to disengage may be based on a comparison between the path of progress of the set and a desired path of progress of the vehicle.

At least one of the determining of whether to engage and whether to disengage may be based on an assessment of a risk level associated with the progress of the set.

At least one of the determining of whether to engage and whether to disengage may be based on an assessment of a risk level associated with road conditions.

At least one of the determining of whether to engage and whether to disengage may be based on an assessment of a risk level imposed by an entrance of a vehicle between members of a convoy.

At least one of the determining of whether to engage and whether to disengage may be based on a physiological state of a driver of the vehicle.

At least one of the determining of whether to engage and whether to disengage may be based on at least one out of (a) a relationship between a type of the vehicle and a type of the certain vehicle, (b) a relationship between a size of the vehicle and a size of the certain vehicle, and (c) a relationship between a weight of the vehicle and a weight of the certain vehicle.

The engaging the vehicle platooning comprises engaging as a leading vehicle.

The engaging the vehicle platooning comprises engaging as a following vehicle.

The engaging comprises engaging the platooning at certain location, and then replacing locations with at least one other vehicle.

The method may include receiving commands conveyed over vehicle to vehicle communication, wherein the commands may be for determining driving of vehicles while engaged in the vehicle platooning.

The at least partially autonomously driving the vehicle may be executed regardless of the commands

The method may include analyzing an accuracy of the commands and generating an alerts when the commands may be inaccurate.

The method may include analyzing an accuracy of the commands and disengaging when the commands may be inaccurate.

The method may include dynamically determining am amount of control of the vehicle during the at least partially autonomously driving of the vehicle.

There may be provided a non-transitory computer readable medium for vehicle to vehicle communication less vehicle platooning, the non-transitory computer readable medium stores instructions for: monitoring by a vehicle monitor, an environment of the vehicle to provide monitoring results; determining, based on the sensed information, whether to engage in vehicle platooning with a set of at least one other vehicle; engaging the vehicle platooning following determination to engage in the vehicle platooning; wherein the engaging comprises at least partially autonomously driving the vehicle based on the monitoring results.

The method may include determining, based at least on the monitoring results, whether disengage the vehicle platooning.

At least one of the determining of whether to engage and whether to disengage may be based on a risk level associated with the vehicle platooning.

At least one of the determining of whether to engage and whether to disengage may be based on a comparison between the path of progress of the set and a desired path of progress of the vehicle.

At least one of the determining of whether to engage and whether to disengage may be based on an assessment of a risk level associated with the progress of the set.

At least one of the determining of whether to engage and whether to disengage may be based on an assessment of a risk level associated with road conditions.

At least one of the determining of whether to engage and whether to disengage may be based on an assessment of a risk level imposed by an entrance of a vehicle between members of a convoy.

At least one of the determining of whether to engage and whether to disengage may be based on a physiological state of a driver of the vehicle.

At least one of the determining of whether to engage and whether to disengage may be based on at least one out of (a) a relationship between a type of the vehicle and a type of the certain vehicle, (b) a relationship between a size of the vehicle and a size of the certain vehicle, and (c) a relationship between a weight of the vehicle and a weight of the certain vehicle.

The engaging the vehicle platooning comprises engaging as a leading vehicle.

The engaging the vehicle platooning comprises engaging as a following vehicle.

The engaging comprises engaging the platooning at certain location, and then replacing locations with at least one other vehicle.

The method may include receiving commands conveyed over vehicle to vehicle communication, wherein the commands may be for determining driving of vehicles while engaged in the vehicle platooning.

The at least partially autonomously driving the vehicle may be executed regardless of the commands

The method may include analyzing an accuracy of the commands and generating an alerts when the commands may be inaccurate.

The method may include analyzing an accuracy of the commands and disengaging when the commands may be inaccurate.

The method may include dynamically determining am amount of control of the vehicle during the at least partially autonomously driving of the vehicle.

There may be provided a system for vehicle to vehicle communication less vehicle platooning, the system may include a vehicle monitor that may be configured to: (i) monitor an environment of the vehicle to provide monitoring results; (ii) determine, based on the sensed information, whether to engage in vehicle platooning with a set of at least one other vehicle; (iii) and participate in engaging the vehicle platooning following determination to engage in the vehicle platooning; wherein the engaging comprises at least partially autonomously driving the vehicle based on the monitoring results.

The vehicle monitor may include a processor and a memory unit. The vehicle monitor may include one or more sensors or may receive sensed information from one or more sensors. The vehicle monitor may include a module for controlling the at least partially autonomously driving of the vehicle and/or may communicate and/or send requests and/or commands to such module. The participation may include sensing a request, triggering, sending a command, providing information, partially or fully executing the at least partially autonomously driving the vehicle.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on non-transitory computer readable media permanently, removably or remotely coupled to an information processing system. The non-transitory computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for at least partial autonomous driving based on one or more other vehicles, the method comprises:
detecting a trusted vehicle within an environment of a first vehicle, the first vehicle is destined to follow a first path and reach a first target location, the trusted vehicle is destined to follow a second path;
determining, based on at least a spatial relationship between the first path and the second path, at least one out of:
(a) whether to perform an at least partial autonomous driving session that involves at least partially automatically following the trusted vehicle, and
(b) whether to suggest to a human driver of the first vehicle to authorize the first vehicle to perform the at least partial autonomous driving session; and
responding to the determination;
wherein the responding comprises at least one out of:
(a) performing the at least partial autonomous driving session when determining to perform the at least partial autonomous driving session; and
(b) suggesting the human driver to authorize the first vehicle to perform the at least partial autonomous driving session, when determining to suggest the human driver to authorize the first vehicle to perform the at least partial autonomous driving session.

2. The method according to claim 1 comprising monitoring an environment of the first vehicle during the performing of the at least partial autonomous driving session to provide monitoring results; and determining by the first vehicle whether to terminate the at least partial autonomous driving session, based on the monitoring results.

3. The method according to claim 1 comprising displaying to the human driver at least one out of (a) information regarding the trusted vehicle, and (b) the first path and the second path.

4. The method according to claim 1 wherein the determining is based, at least in part, on a spatial relationship between the first path and the second path.

5. The method according to claim 1 comprising generating feedback regarding a driving of the trusted vehicle during the at least partial autonomous driving session and sending the feedback to a remote system for recalculation of a trust attribute associated with the trusted driver.

6. The method according to claim 1 wherein the determining comprises obtaining a driving profile of the human driver, obtaining a driving profile of the trusted vehicle, calculating a similarity between the driving profile of the human driver and the driving profile of the trusted vehicle, and wherein the determining is based, at least in part, on the similarity.

7. The method according to claim 1 wherein the performing of the at least partial autonomous driving session comprises utilizing vehicle to vehicle communication between the first vehicle and the trusted vehicle.

8. The method according to claim 1 wherein the performing of the at least partial autonomous driving session comprises is executed without utilizing vehicle to vehicle communication between the first vehicle and the trusted vehicle.

9. The method according to claim 1 wherein the determining is based, at least in part, on a number of vehicles that are already engaged in at least partially automatically following the trusted vehicle.

10. The method according to claim 1 wherein the first vehicle is associated with a first trust level and the trusted vehicle is associated with a second trust level, wherein the determining is based at least in part on the first trust level and on the second trust level.

11. The method according to claim 1 wherein the first vehicle is associated with a first trust level and the trusted vehicle is associated with a second trust level, wherein the determining is based at least in part on the first trust level and on the second trust level.

12. The method according to claim 1 comprising detecting at least one additional trusted vehicle within the environment of the vehicle, wherein the at least one additional trusted vehicle is destined to follow at least one path.

13. The method according to claim 1 comprising detecting at least one additional trusted vehicle within the environment of the vehicle, wherein the at least one additional trusted vehicle is destined to follow at least one path.

14. The method according to claim 13 wherein the determining comprises selecting a trusted vehicle of the first trusted vehicle and the at least one additional trusted vehicle.

15. The method according to claim 13 wherein the determining comprises selecting, for each first path segment out of multiple first path segments, a trusted vehicle of the first trusted vehicle and the at least one additional trusted vehicle.

16. The method according to claim 13 wherein the determining comprises selecting a trusted vehicle of the first trusted vehicle and the at least one additional trusted vehicle.

17. The method according to claim 13 wherein the determining comprises selecting, for each first path segment out of multiple first path segments, a trusted vehicle of the first trusted vehicle and the at least one additional trusted vehicle.

18. A non-transitory computer readable medium for at least partial autonomous driving based on one or more other vehicles, the non-transitory computer readable medium stores instructions for:
detecting a trusted vehicle within an environment of a first vehicle, the first vehicle is destined to follow a first path and reach a first target location, the trusted vehicle is destined to follow a second path;
determining, based on at least a spatial relationship between the first path and the second path, at least one out of:
(a) whether to perform an at least partial autonomous driving session that involves at least partially automatically following the trusted vehicle, and
(b) whether to suggest to a human driver of the first vehicle to authorize the first vehicle to perform the at least partial autonomous driving session; and
responding to the determination;
wherein the responding comprises at least one out of:
(i) performing the at least partial autonomous driving session when determining to perform the at least partial autonomous driving session; and
(ii) suggesting the human driver to authorize the first vehicle to perform the at least partial autonomous driving session, when determining to suggest the human driver to authorize the first vehicle to perform the at least partial autonomous driving session.

19. The non-transitory computer readable medium according to claim 18 that stores instructions for monitoring an environment of the first vehicle during the performing of the at least partial autonomous driving session to provide monitoring results; and determining by the first vehicle whether to terminate the at least partial autonomous driving session, based on the monitoring results.

20. The non-transitory computer readable medium according to claim 18 that stores instructions for displaying to the human driver at least one out of (a) information regarding the trusted vehicle, and (b) the first path and the second path.
